(19) United States
(12) Patent Application Publication
(10) Pub. No.: US 2014/0210749 A1
(43) Pub. Date: Jul. 31, 2014

(54) TOUCH PANEL

(71) Applicant: SAMSUNG ELECTRO-MECHANICS CO., LTD., Suwon-si (KR)

(72) Inventors: Jang Ho Park, Suwon-si (KR); Jung Ryoul Yim, Suwon-si (KR); Jae Chan Park, Suwon-si (KR)

(73) Assignee: SAMSUNG ELECTRO-MECHANICS CO., LTD., Suwon-si (KR)

(21) Appl. No.: 14/165,356

(22) Filed: Jan. 27, 2014

(30) Foreign Application Priority Data
Jan. 29, 2013 (KR) 10-2013-0009940

(51) Int. Cl. G06F 3/041

(52) U.S. Cl. CPC G06F 3/041
USPC 345/173

(57) ABSTRACT

Disclosed herein is a touch panel, including: a transparent substrate; an insulating pattern formed on the transparent substrate; and an electrode pattern formed on the insulating pattern in a pattern corresponding to the insulating pattern and having an aperture ratio larger than that of the insulating pattern. According to the preferred embodiment of the present invention, it is possible to improve the visibility of the touch panel by reducing the user's recognition of the electrode pattern.

### CROSS REFERENCE TO RELATED APPLICATION

This application claims the benefit of Korean Patent Application No. 10-2013-0009940, filed on Jan. 29, 2013, entitled “Touch Panel” which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing technologies beyond the level of satisfying general functions. To this end, a touch panel has been developed as an input device capable of inputting information such as text, graphics, or the like.

This touch panel is mounted on a display surface of a display such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the display.

In addition, the touch panel is classified into a resistive type, a capacitive type, an electromagnetic type, a surface acoustic wave (SAW) type, and an infrared type. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, as the touch panel described in the following Patent Document described in the following Prior Art Document, researches for forming electrode patterns using metals have been actively conducted. As described above, when the electrode pattern is formed of metal, there are advantages in that electric conductivity is excellent and a demand and supply is smooth. However, when the electrode pattern is formed of metal, there is a problem in that a user may recognize the electrode patterns. In order to prevent an electrical short from the individual electrode patterns during the process of forming the electrode patterns, the short portions between the electrode patterns are formed to insulate between the electrode patterns, but a shape of the short portions are differentiated from the electrode patterns, such that the recognition of the electrode patterns may be more increased by a user.

### PRIOR ART DOCUMENT

### Patent Document

(Patent Document 1) JP2011-175967 A

### SUMMARY OF THE INVENTION

The present invention has been made in an effort to provide a touch panel with improved visibility by forming the same insulating patterns in the insulating portion between the respective electrode patterns when the electrode patterns are formed using metal so as to form the overall uniform electrode patterns.

According to a preferred embodiment of the present invention, there is provided a touch panel, including: a transparent substrate; an insulating pattern formed on the transparent substrate; and an electrode pattern formed on the insulating pattern in a pattern corresponding to the insulating pattern and having an aperture ratio larger than that of the insulating pattern.

The electrode pattern may be formed with a short portion to electrically insulate between at least two electrode patterns and the insulating pattern corresponding to the short portion may be formed in a pattern corresponding to the electrode pattern other than the short portion.

The insulating pattern and the electrode pattern may be formed in a mesh pattern.

The electrode pattern may be formed to correspond to the insulating pattern and a difference between the aperture ratio of the electrode pattern and the aperture ratio of the insulating pattern may be formed to be in a range between 0.01% and 5%.

The electrode pattern may be formed of copper (Cu), aluminum (Al), gold (Au), silver (Ag), titanium (Ti), palladium (Pd), chromium (Cr), nickel (Ni), or a combination thereof.

The touch panel may further include: bezel layers formed at both ends of the window substrate, wherein the transparent substrate is a window substrate that is formed at an outermost side of the touch panel and receives a touch value input by a user, and the insulating pattern is formed to have a step corresponding to the bezel layer.

According to another preferred embodiment of the present invention, there is provided a touch panel, including: a transparent substrate; first electrode patterns formed on one surface of the transparent substrate so as to be in parallel with each other in one direction; an insulating pattern formed on one surface of the transparent substrate formed with the first electrode pattern and formed in a pattern corresponding to the first electrode pattern; and a second electrode pattern formed on the other surface of the transparent substrate and formed in a direction in which the second electrode pattern intersects the first electrode pattern, wherein the insulating pattern has an aperture ratio larger than that of the first electrode pattern.

The touch panel may further include: a window substrate bonded to the first electrode pattern on one surface of the transparent substrate so as to face the first electrode pattern.

The first electrode pattern may be formed with a short portion to electrically insulate between at least two first electrode patterns and the insulating pattern at a position corresponding to the short portion may be formed in a pattern corresponding to the first electrode pattern other than the short portion.

A difference between the aperture ratio of the first electrode pattern and the aperture ratio of the insulating pattern may be in a range between 0.01% and 5%.

The insulating pattern, the first electrode pattern, and the second electrode pattern may be formed in a mesh pattern.

The first electrode pattern and the second electrode pattern may be formed of copper (Cu), aluminum (Al), gold (Au), silver (Ag), titanium (Ti), palladium (Pd), chromium (Cr), nickel (Ni), or a combination thereof.

According to still another preferred embodiment of the present invention, there is provided a touch panel, including: a first transparent substrate; first electrode patterns formed on one surface of the first transparent substrate so as to be in parallel with each other in one direction; an insulating pattern formed on the first electrode pattern in a pattern corresponding to the first electrode pattern and having an aperture ratio smaller than that of the first electrode pattern; a second transparent substrate; and a second electrode pattern formed on one surface of the second transparent substrate so as to be in parallel with each other in a direction in which the second electrode intersects the first electrode pattern, wherein the first transparent substrate and the second transparent substrate are bonded to the other surface of the first transparent substrate so as to face the second electrode pattern of the second transparent substrate.

The first electrode pattern may be formed with a short portion to electrically insulate between at least one first electrode patterns and the insulating pattern facing the short portion may be formed in a pattern corresponding to the first electrode pattern other than the short portion.

According to yet another preferred embodiment of the present invention, there is provided a touch panel, including: a window substrate; bezel layers formed at both ends of the window substrate; an insulating pattern formed to have a step corresponding to the bezel layer; a first transparent substrate; first electrode patterns formed on one surface of the first transparent substrate so as to be in parallel with in one direction and formed to have an aperture ratio larger than that of the insulating pattern; a second transparent substrate; and a second electrode pattern formed on one surface of the second transparent substrate so as to be in parallel with each other in a direction in which the second electrode intersects the first electrode pattern, wherein the first transparent substrate and the second transparent substrate are bonded to the other surface of the first transparent substrate so as to face the second electrode pattern of the second transparent substrate.

The bezel layer may be formed of a carbon-based material (graphene oxide, diamond line carbon (DLC)), chromium-based oxide (CrO, CrO₂), copper-based oxide (CuO), manganese-based oxide (MnO₂), cobalt-based oxide (CoO), sulfides (CoS₂, Co₃S₄), nickel-based oxide (Ni₂O₃), titanate oxide (TiO₂), aluminum oxide (Al₂O₃), magnesium-based oxide (MgO), sodium-based oxide (Na₂O), lithium-based oxide (Li₂O), beryllium-based oxide (BeO), magnesium-based sulfide (MgS), or a combination thereof.

The first electrode pattern may be formed with a short portion to electrically insulate between at least one first electrode patterns and the insulating pattern facing the short portion may be formed in a pattern corresponding to the first electrode pattern other than the short portion.

The insulating pattern and the electrode pattern may be formed in a mesh pattern.

The electrode pattern may be formed to correspond to the insulating pattern and a difference between the aperture ratio of the electrode pattern and the aperture ratio of the insulating pattern may be formed to be in a range between 0.01% and 5%.

The electrode pattern may be formed of copper (Cu), aluminum (Al), gold (Au), silver (Ag), titanium (Ti), palladium (Pd), chromium (Cr), nickel (Ni), or a combination thereof.

An adhesive layer formed of an optically clear adhesive may be formed between the window substrate and the transparent substrate.

According to still yet another preferred embodiment of the present invention, there is provided a touch panel, including: a window substrate; bezel layers formed at both ends of the window substrate; an insulating pattern formed to have a step corresponding to the bezel layer; a transparent substrate; a first electrode pattern formed on one surface of the transparent substrate in a pattern corresponding to the insulating pattern and having an aperture ratio larger than that of the insulating pattern; and a second electrode pattern formed on the other surface of the transparent substrate and formed in a direction in which the second electrode pattern intersects the first electrode pattern, wherein the window substrate is bonded to one surface of the transparent substrate in a direction in which the window substrate faces one surface of the transparent substrate.

The first electrode pattern may be formed with a short portion to electrically insulate between at least one first electrode patterns and the insulating pattern facing the short portion may be formed in a pattern corresponding to the first electrode pattern other than the short portion.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch panel according to a first preferred embodiment of the present invention;

FIG. 2 is a cross-sectional view of a touch panel according to a second preferred embodiment of the present invention;

FIG. 3 is a plan view of an electrode pattern including a short portion according to a preferred embodiment of the present invention;

FIG. 4 is a plan view of an insulating pattern having the same pattern as an electrode pattern according to a preferred embodiment of the present invention;

FIG. 5 is a plan view of an appearance in which an electrode pattern and an insulating pattern according to the preferred embodiment of the present invention are stacked;

FIG. 6 is a plan view of the touch panel according to the preferred embodiment of the present invention;

FIG. 7 is a cross-sectional view of a touch panel according to a third preferred embodiment of the present invention;

FIG. 8 is a cross-sectional view of a touch panel according to a fourth preferred embodiment of the present invention;

FIG. 9 is a cross-sectional view of a touch panel according to a fifth preferred embodiment of the present invention; and

FIG. 10 is a cross-sectional view of a touch panel according to a sixth preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

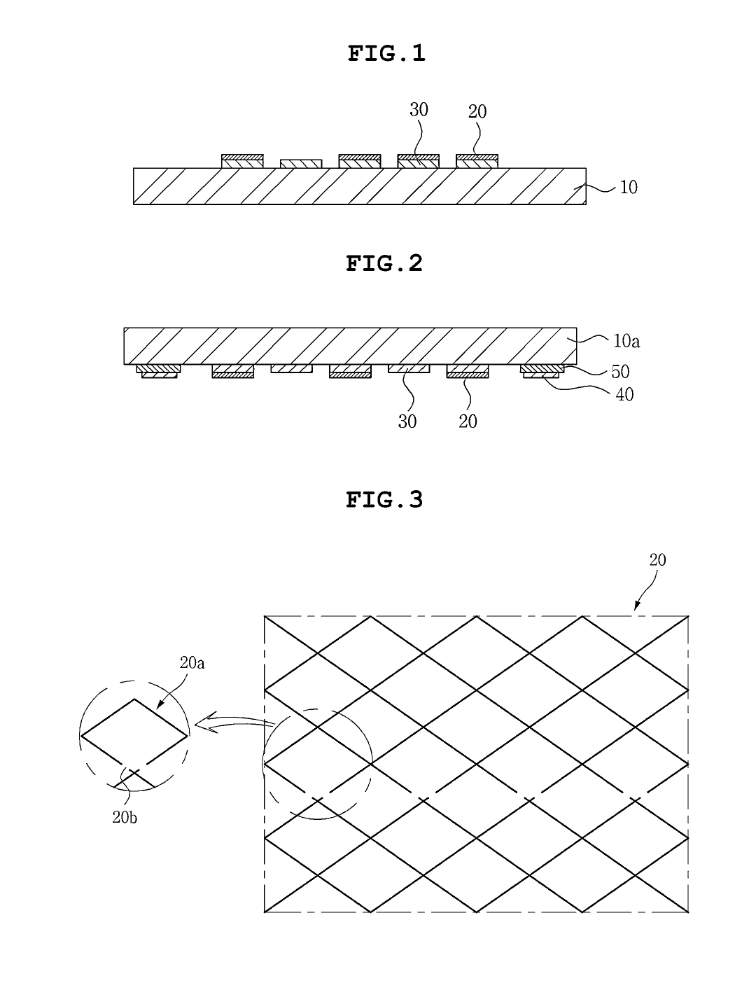

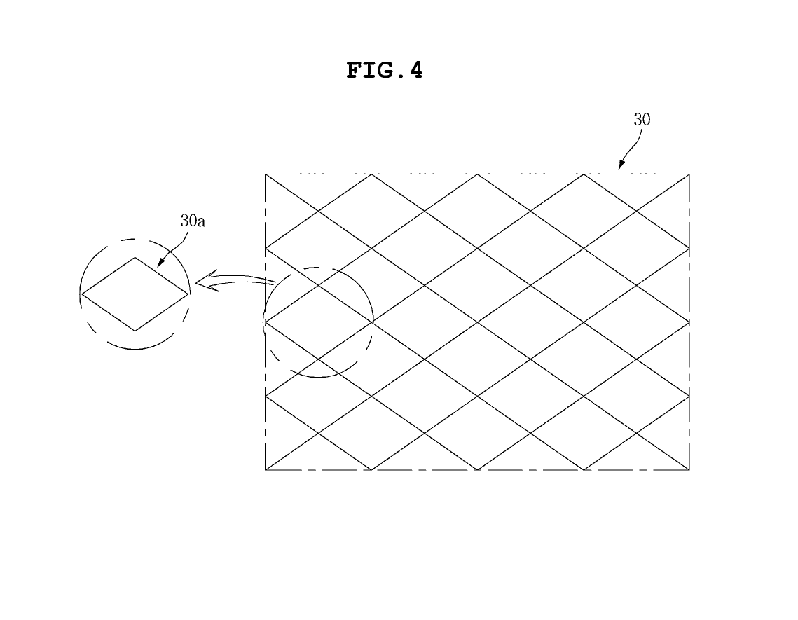

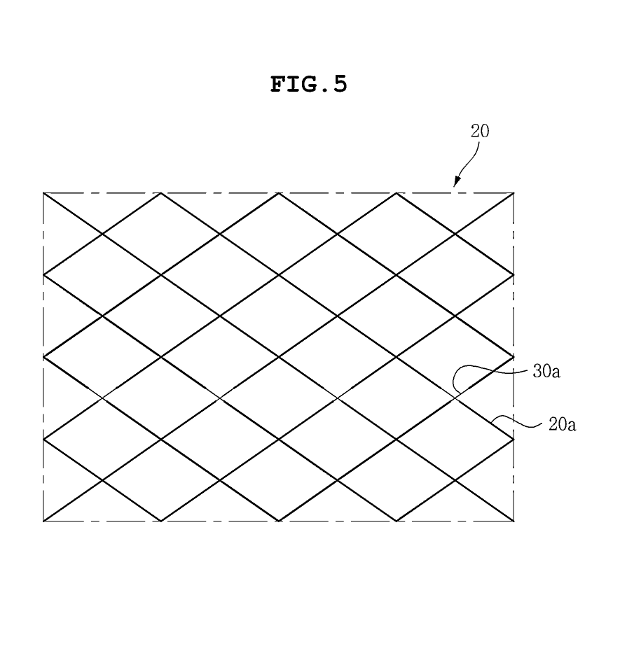

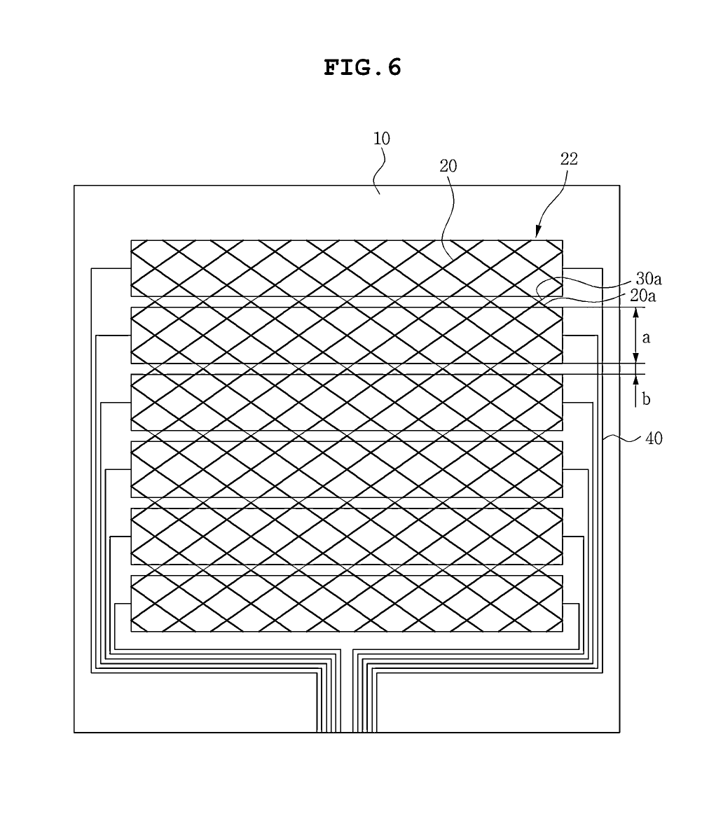

FIG. 1 is a cross-sectional view of a touch panel according to a first preferred embodiment of the present invention, FIG. 2 is a cross-sectional view of a touch panel according to a second preferred embodiment of the present invention, FIG. 3 is a plan view of an electrode pattern including a short portion according to a preferred embodiment of the present invention, FIG. 4 is a plan view of an insulating pattern having the same pattern as an electrode pattern according to a preferred embodiment of the present invention, FIG. 5 is a plan view of an appearance in which an electrode pattern and an insulating pattern according to the preferred embodiment of the present invention are stacked, and FIG. 6 is a plan view of the touch panel according to the preferred embodiment of the present invention.

The touch panel according to the first preferred embodiment of the present invention may include a transparent substrate 10, insulating patterns 30 formed on the transparent substrate 10, and electrode patterns 20 that are formed on the insulating patterns 30 in a pattern corresponding to the insulating patterns 30 and have an aperture ratio larger than that of the insulating patterns 30.

The transparent substrate 10 is formed of any material having a predetermined strength or more without being particularly limited, but the transparent substrate 10 may be formed of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass, and the like. Further, one surface of the transparent substrate 10 may be formed with a transparent electrode, and therefore in order to improve an adhesion between the transparent substrate 10 and the transparent electrode, the one surface of the transparent substrate 10 may be subjected to a high frequency treatment, primer treatment, and the like, to form a surface treatment layer.

Here, the transparent substrate 10 is formed at an outermost side of the touch panel, and thus may be a window substrate 10a receiving a touch value input by a user. As illustrated in FIG. 2, when the transparent substrate 10 is the window substrate 10a, the window substrate 10a may be formed with the bezel layer 50 that is formed at an edge portion of a touch screen that is an inactive region other than a touch region. In this case, if the bezel layer 50 is formed of an insulating material, the insulating patterns 30 may be formed, simultaneously with forming the bezel layers 50.

That is, the insulating patterns 30 may be formed on the window substrate 10a, simultaneously with the bezel layer 50 formed to cover the electrode wirings 40. That is, the insulating patterns 30 are formed simultaneously with the bezel layers 50, and thus a separate process of forming the insulating patterns 30 is unnecessary, thereby solving the problems in that the process of forming the insulating patterns 30 is complicated and the reliability of the formation of the insulating patterns 30 is degraded. Further, as illustrated in FIG. 2, steps generated at the time of electrically connecting the electrode wirings 40 formed for electrical connection with the electrode patterns 20 with the electrode patterns 20 formed on the insulating patterns 30 are compensated by the insulating patterns 30, such that the electrical connection between the electrical patterns 20 and the electrode wirings 40 may be made on the same plane, thereby more improving the reliability of the electrical connection between the electrode wirings 40 and the electrode patterns 20. That is, the bezel layer 50 and the insulating patterns 30 are formed at the same height to have the same step, thereby securing the reliability of electrical connection as described above.

In detail, the bezel layer 50 serves to cover the electrode wirings 40 or display a logo, and the like, and may be formed on one surface of the window substrate 10a. Meanwhile, the bezel layer 50 may be formed, for example, using a sputter. When the bezel layer 50 is formed using the sputter, a thickness of the bezel layer 50 may be thinly formed up to a nanometer unit.

Further, the bezel layer 50 may be formed in black, white, gold, red, green, yellow, gray, violet, brown, or blue, or a combination thereof. Materials for forming the bezel layers 50 in each color as described above will be described below in detail.

First, when carbon-based materials (graphene oxide, diamond line carbon (DLC), chromium-based oxide (CrO, CrO₂), copper-based oxide (CuO), manganese-based oxide (MnO₂), cobalt-based oxide (CoO), sulfides (CoS₂, Co₃S₄), nickel-based oxide (Ni₂O₃), HgTe, YBa₂Cu₃O7, MoS₂, RuO₂, PdO, InP, SnO, TaN, TaS₂, and the like, are used, the bezel layer 50 may be formed in black.

Further, when titanate oxide (TiO₂), aluminum-based oxide (Al₂O₃), magnesium-based oxide (MgO), sodium-based oxide (Na₂O), lithium-based oxide (Li₂O), beryllium-based oxide (BeO), magnesium-based sulfide (MgS), and the like, are used, the bezel layer 50 may be formed in white.

Further, when titanate nitride (TiN), and the like, is used, the bezel layer 50 may be formed in gold and when copper-based oxide (Cu₂O), iron-based oxide (Fe₂O₃), ZnTe, Tris (bipyridine) ruthenium chloride, PdCl2, CdSe, and the like, are used, the bezel layer 50 may be formed in red.

In addition, when chromium-based oxide (Cr₂O₃), MnO, NiO, MoCl₅, biI₃, and the like, are used, the bezel layer 50 may be formed in green and when sodium-based oxide (Na₂O₂), K₂O, CaO, V₂O₅, ZnSe, GaN, GaP, Rb₂O, NbCl₅, CdS, CdI₂, In₂O₃, Sb₂O₅, Cs₂O, WO₃, Bi₂O₃, and the like, are used, the bezel layer 50 may be formed in yellow.

In addition, when MgB₂, Si₃N₄, RbOH, BaO₂, ZrC, NbO, MoSi₂, WC, Bi₂Te₃, and the like, are used, the bezel layer 50 may be formed in gray and when Ru(acac)₃, and the like, is used, the bezel layer 50 may be formed in violet.

Further, when Pd(O₂CCH₃)₂, CdO, InSb, Tantalum carbide, and the like, are used, the bezel layer 50 may be formed in brown and when WCI₆, and the like, is used, the bezel layer 50 may be formed in blue.

The electrode patterns 20 generate signals by an input unit of a touch and allows a control unit (not illustrated) to recognize touched coordinates. According to the exemplary embodiment of the present invention, the electrode patterns 20 may be formed on the insulating patterns 30. The electrode patterns 20 and the insulating patterns 30 may be formed in mesh patterns having the same pattern. However, short portions 20b formed to electrically insulate between more than two electrode patterns 20 break a regularity of the electrode patterns 20, such that there is a problem in that a user may recognize the electrode patterns 20. Therefore, as described above, the same pattern as the electrode patterns 20 other than the short portions 20b is maintained even at a position at which the insulating patterns 30 correspond to the short portion 20b of the electrode patterns 20 and the user maintains the regularity of the electrode patterns, thereby reducing the visibility of the electrode patterns 20.

Here, the electrode patterns 20 may be formed in a mesh pattern using copper (Cu), aluminum (Al), gold (Au), silver (Ag), titanium (Ti), palladium (Pd), and chromium (Cr), nickel (Ni), or a combination thereof. In particular, the mesh pattern may be formed by continuously arranging at least one unit pattern 20a. Herein, the unit pattern 20a may be formed in a square, a triangle, a diamond, and other various shapes and in the exemplary embodiment of the present invention, the diamond-shaped unit pattern 20a is illustrated and is mainly described.

When the exemplary embodiment of the present invention uses the electrode patterns 20 in the mesh pattern formed of opaque metals, the regularity of the electrode patterns 20 is broken due to the short portions 20b formed to insulate between the insulating patterns 20, and thus the electrode patterns 20 are remarkably recognized by the user, thereby solving the problem in that the overall visibility of the touch panel may be affected. Therefore, in the exemplary embodiment of the present invention, in order to prevent the electrode patterns 20 from being dividedly recognized due to the short portions 20b for electrical insulation between the electrode patterns 20, the insulating patterns 30 and the electrode patterns 20 are formed on the same plane or a plane facing each other so that the shape of the electrode patterns 20 may be originally maintained at positions corresponding to the short portions 20b of the electrode patterns 20.

Meanwhile, in addition to the foregoing metals, the electrode patterns 20 may also be formed of metal silver formed by exposing/developing a silver salt emulsion layer, metal oxide such as indium tin oxide (ITO), and the like, or conductive polymer such as PEDOT/PSS, and the like, having excellent flexibility and simple coating process.

A method of forming the electrode patterns 20 may be formed by a dry process, a wet process, or a direct patterning process. Herein, the dry process includes sputtering, evaporation, and the like, the wet process includes dip coating, spin coating, roll coating, spray coating, and the like, and the direct patterning process includes screen printing, gravure printing, inkjet printing, and the like.

Further, a photosensitive material is applied on the insulating pattern 30 or the electrode pattern 20 on the substrate by using photolithography and light is irradiated using a mask formed in a desired pattern. In this case, a developing process for forming a desired pattern by removing a photosensitive material portion receiving light with a developer or a portion not receiving light with a developer, and the like, is performed. Next, when the photosensitive material is formed in a specific pattern and the remaining portion is removed with an etchant using the photosensitive material as a resist and then photosensitive material is removed, the insulating pattern 30 or the electrode pattern 20 in the desired pattern may be manufactured.

Further, the insulating pattern 30 or the electrode pattern 20 may also be formed using a lift-off manner The lift off method is simpler than the evaporation process, the photolithography process, and the like, and does not have to manufacture a separate mask and use an expensive exposure device. At the time of forming the insulating patterns 30 or the electrode patterns 20 of the touch panel according to the preferred embodiment of the present invention, a case of using the lift off method will be simply described below.

First, when a fine pattern is formed using a printing method, a bank (not illustrated) that is a compartment member is formed on the substrate in order to improve a precision of a pattern line width. The bank is formed on the transparent substrate 10 to partition a region other than the desired pattern from a predetermined region. As materials of the bank, photo acryl, polyimide, polyvinylalcohol, polyvinyl chloride, polyacryl amide, polyethylene glycol, and the like, may be used The selection of these materials is made to prevent materials forming the insulating pattern 30 or the electrode pattern 20 from being solved or damaged, such that appropriate materials may be selected and applied according to the materials of the insulating patterns 30 or the electrode patterns 20 by those skilled in the art.

Next, insulating materials forming the insulating patterns 30 or metal materials used for the electrode patterns 20 are applied to the substrate on which the bank is formed. As the method, screen printing, offset printing, spin coating, and the like, may be selectively applied.

Finally, the insulating patterns 30 or the electrode patterns 20 may also be formed using the lift off method. The lift-off method performs a process of lifting-off the bank portion in which the insulating patterns 30 or the electrode patterns 20 are formed, thereby forming the desired insulating patterns 30 or electrode patterns 20. Herein, as an example of the lift-off method, the insulating patterns 30 or the electrode patterns 20 formed on the bank may be removed together in the present step, by the process of removing the bank using a solution solving the material forming the bank. Therefore, only the insulating pattern 30 or the electrode pattern 20 that does not include the bank remains, such that the desired insulating pattern 30 and electrode pattern 20 can be obtained.

The electrode pattern 20 and the insulating pattern 30 are formed in the same pattern, but as described above, the pattern of the short portion 20b is formed to insulate between the electrode patterns 20, thereby forming the difference in patterns. In particular, more than two electrode patterns 20 are insulated by the short portions 20b of the electrode patterns 20, such that the difference in the aperture ratio between the respective patterns of the insulating patterns 30 and the electrode patterns 20 occurs. The aperture ratio of the electrode pattern 20 in which the short portion 20b is formed is larger than that of the insulating pattern 30, in detail, the difference in both aperture ratios is appropriately formed within a range of about 5%. Since the electrode pattern 20 and the insulating pattern 30 may not have the same aperture ratio, the electrode pattern 20 and the insulating pattern 30 are within a range of about 5%, but the electrode pattern 20 and the insulating pattern 30 having the same aperture ratio that is 0% are excluded.

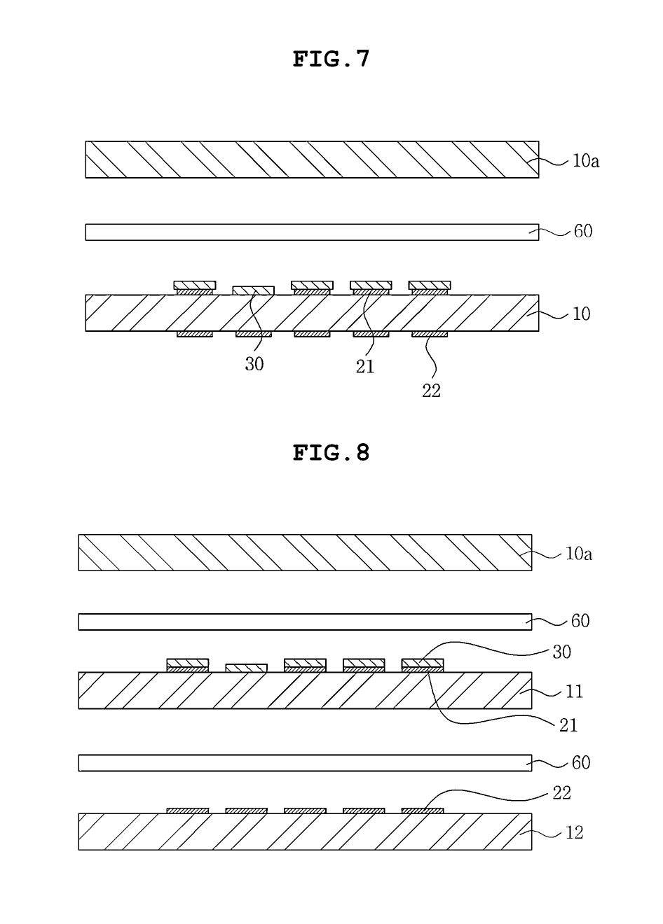

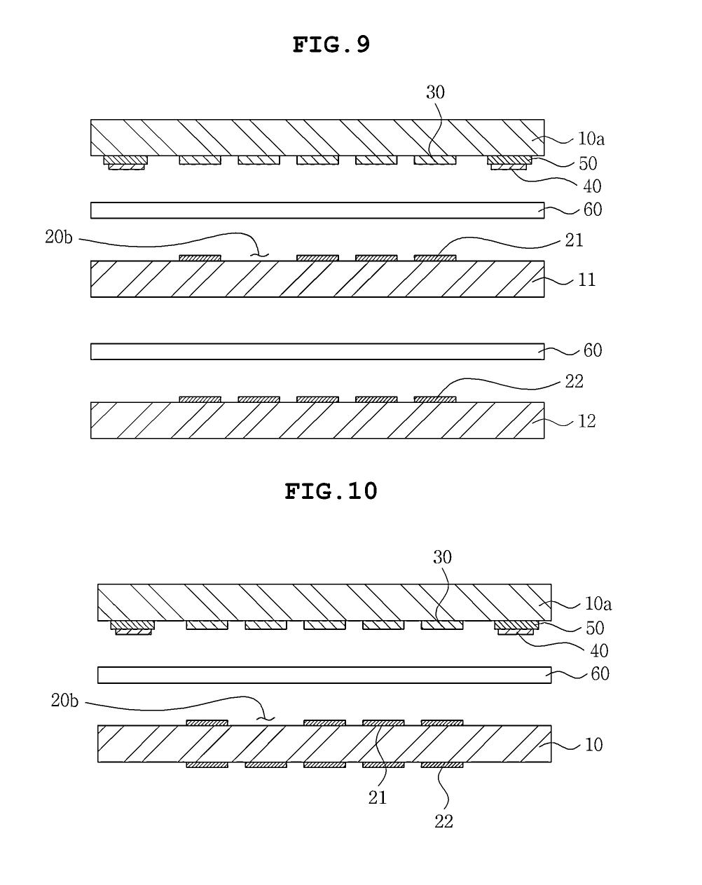

FIG. 7 is a cross-sectional view of a touch panel according to a third preferred embodiment of the present invention, FIG. 8 is a cross-sectional view of a touch panel according to a fourth preferred embodiment of the present invention, FIG. 9 is a cross-sectional view of a touch panel according to a fifth preferred embodiment of the present invention, and FIG. 10 is a cross-sectional view of a touch panel according to a sixth preferred embodiment of the present invention.

A touch panel according to the third preferred embodiment of the present invention includes the transparent substrate 10, first electrode patterns 21 formed on one surface of the transparent substrate 10 so as to be parallel with each other in one direction, the insulating patterns 30 formed on one surface of the transparent substrate 10 formed with the first electrode pattern 21 and formed in patterns corresponding to the first electrode patterns 21, and second electrode patterns 22 formed on the other surface of the transparent substrate 10 and formed in a direction in which the second electrode patterns 22 intersect the first electrode patterns 21, wherein the insulating pattern 30 has an aperture ratio larger than that of the first electrode pattern 21.

As illustrated in FIG. 7, in the touch panel according to the preferred embodiment of the present invention, the first electrode pattern 21 and the second electrode pattern are formed on both surfaces of the transparent substrate 10 and the insulating pattern 30 may be formed on the first electrode pattern 20 in the same pattern as the first electrode pattern 21. Even in this case, although not illustrated, the insulating pattern 30 is formed so that portions each corresponding to the short portion 20b formed for insulation between more than two first electrode patterns 21 and the short portion 20b formed for insulation between the second patterns 22 are continued in the same pattern as each electrode pattern 20, thereby preventing the first electrode pattern 21 and the second electrode pattern 22 from noticeably being recognized by the user due to the short portion 20b. Further, the window substrate 10a on the insulating pattern 30 formed on the first electrode pattern 21 may be further provided on one surface of the transparent substrate 10. The window substrate 10a may be formed of tempered glass to serve as a protective layer.

The touch panel according to the fourth preferred embodiment of the present invention includes a first transparent substrate 11, the first electrode patterns 21 formed on the first transparent substrate 11 so as to be in parallel with each other in one direction, the insulating patterns 30 formed on the first electrode pattern 21 in the corresponding pattern and having an aperture ratio smaller than that of the first electrode pattern 21, a second transparent substrate 12, and the second electrode patterns 22 formed on the one surface of the second transparent substrate 12 so as to be in parallel with each other in a direction in which the second electrode patterns 22 intersect the first electrode patterns 21, wherein the first transparent substrate 11 and the second transparent substrate 12 may be bonded to the other surface of the first transparent substrate 11 by the optically clear adhesive 60 so that the second electrode patterns 22 of the second transparent substrate 12 face each other.

As illustrated in FIG. 8, the first transparent substrate 11 is bonded to the second transparent substrate 12 by the optically clear adhesive 60, thereby manufacturing the touch panel. The first electrode patterns 21 may be formed on one surface of the first transparent substrate 11 and the insulating patterns 30 may be formed on the first electrode patterns 21.

In this case, as described above, the insulating patterns 30 are formed at all the portions, including the short portion 20b of the first electrode pattern 21, thereby preventing the visibility of the touch panel from reducing due to the recognition of the first electrode patterns 21 due to the short portions 20b of the first electrode patterns 21. The insulating pattern 30 may be formed on the transparent substrate 10 in the same pattern as the electrode pattern 20, such that the short portion 20b of the second electrode pattern 22 formed to intersect the first electrode pattern 21 may identically reduce the visibility thereof.

The touch panel according to the fifth preferred embodiment of the present invention includes the window substrate 10a, the insulating patterns 30 formed at both ends of the window substrate 10a, along with the bezel layer 50, the transparent substrate 10, the first electrode patterns 21 formed on one surface of the transparent substrate 10 in a pattern corresponding to the insulating patterns 30 and having an aperture ratio larger than that of the insulating pattern 30, and the second electrode patterns 22 formed on the other surface of the transparent substrate 10 and formed in a direction in which the second electrode patterns intersect the first electrode patterns 21, wherein the window substrate 10a may be bonded to one surface of the transparent substrate 10 in a direction facing each other by the optically clear adhesive 60.

As illustrated in FIG. 9, the touch panel according to the fifth preferred embodiment of the present invention may form the first electrode pattern 21 and the second electrode pattern 22 each formed on the first transparent substrate 11 and the second transparent substrate 12, as in the fourth preferred embodiment of the present invention. However, according to the preferred embodiment of the present invention, the insulating pattern 30 is formed on the window substrate 10a, simultaneously with forming the bezel layer 50 on the window substrate 10a, thereby more improving the easiness and reliability of manufacturing.

The touch panel according to the sixth preferred embodiment of the present invention includes the window substrate 10a, the insulating patterns 30 formed at both ends of the window substrate 10a, along with the bezel layer 50, the transparent substrate 10, the first electrode patterns 21 formed on one surface of the transparent substrate 10 in a pattern corresponding to the insulating patterns 30 and having an aperture ratio larger than that of the insulating pattern 30, and the second electrode patterns 22 formed on the other surface of the transparent substrate 10 and formed in a direction in which the second electrode patterns intersect the first electrode patterns 21, wherein the window substrate 10a may be bonded to one surface of the transparent substrate 10 in a direction facing each other.

As illustrated in FIG. 10, the touch panel according to the sixth preferred embodiment of the present invention may form the first electrode pattern 21 and the second electrode pattern 22 on both surfaces of the transparent substrate 10, respectively, as in the third preferred embodiment of the present invention. However, according to the preferred embodiment of the present invention, the window substrate may be bonded to the first electrode pattern 21 in a direction facing each other. Herein, the insulating pattern 30 may be formed on the window substrate 10a, simultaneously with forming the bezel layer 50 on the window substrate 10a.

Other preferred embodiments commonly have the technical characteristics of reducing the visibility of the electrode pattern 20 by changing the design of the configuration of the first transparent substrate 11, the second transparent substrate 12, the transparent substrate 10, and the transparent substrate 30, the configuration of the first electrode pattern 21, the second electrode pattern 22, and the electrode pattern 20, and the structure between the insulating pattern 30 and the electrode pattern 20, and therefore the description of each configuration and relationship thereof is the same as the description of the configuration corresponding to the first and second preferred embodiments of the present invention. Accordingly, the detailed description thereof will be omitted herein.

According to the preferred embodiments of the present invention, the visibility of the touch panel can be improved by reducing the user's recognition of the electrode patterns.

In addition, the insulating patterns having the same pattern as the mesh pattern forming the electrode patterns can be formed together and the same patterns can be formed in the space for insulating the individual electrode patterns to reduce the recognition of the electrode patterns, thereby improving the visibility of the touch panel.

Further, the insulating patterns capable of reducing the recognition of the short portions of the electrode patterns can be formed without the additional process, by simultaneously forming the bezel layers and the insulating patterns at the time of forming the bezel layers on the outermost window substrate.

In addition, the adhesion of the electrode patterns to the substrate can be more improved by forming the insulating patterns on the substrate and the electrode patterns having the same pattern shape on the insulating substrate, thereby improving the operating performance and driving reliability of the touch panel.

Further, the electrical reliability of the electrode patterns can be secured by solving the problems of reliability such as the electrical short of the electrode patterns, and the like due to foreign materials, and the like, which remain on the substrate when the electrode patterns are directly formed on the substrate, thereby more improving the driving reliability of the touch panel.

Further, the occurrence of the steps between the bezel layers and the electrode patterns can be reduced by simultaneously forming the bezel layers and the insulating patterns on the outermost window substrate to prevent the short of the electrode wirings, and the like, which may occur due to the step, thereby more improving the electrical reliability of the touch panel through the electrode wirings.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
an insulating pattern formed on the transparent substrate; and
an electrode pattern formed on the insulating pattern in a pattern corresponding to the insulating pattern and having an aperture ratio larger than that of the insulating pattern.

2. The touch panel as set forth in claim 1, wherein the electrode pattern is formed with a short portion to electrically insulate between at least two electrode patterns and the insulating pattern corresponding to the short portion is formed in a pattern corresponding to the electrode pattern other than the short portion.

3. The touch panel as set forth in claim 1, wherein the insulating pattern and the electrode pattern are formed in a mesh pattern.

4. The touch panel as set forth in claim 1, wherein the electrode pattern is formed to correspond to the insulating pattern and a difference between the aperture ratio of the electrode pattern and the aperture ratio of the insulating pattern is formed to be in a range between 0.01% and 5%.

5. The touch panel as set forth in claim 1, wherein the electrode pattern is formed of copper (Cu), aluminum (Al), gold (Au), silver (Ag), titanium (Ti), palladium (Pd), chromium (Cr), nickel (Ni), or a combination thereof.

6. The touch panel as set forth in claim 1, further comprising:
bezel layers formed at both ends of the window substrate,
wherein the transparent substrate is a window substrate that is formed at an outermost side of the touch panel and receives a touch value input by a user, and
the insulating pattern is formed to have a step corresponding to the bezel layer.

7. A touch panel, comprising:
a transparent substrate;
first electrode patterns formed on one surface of the transparent substrate so as to be in parallel with each other in one direction;
an insulating pattern formed on one surface of the transparent substrate formed with the first electrode pattern and formed in a pattern corresponding to the first electrode pattern; and
a second electrode pattern formed on the other surface of the transparent substrate and formed in a direction in which the second electrode pattern intersects the first electrode pattern,
wherein the insulating pattern has an aperture ratio larger than that of the first electrode pattern.

8. The touch panel as set forth in claim 7, further comprising:
a window substrate bonded to the first electrode pattern on one surface of the transparent substrate so as to face the first electrode pattern.

9. The touch panel as set forth in claim 7, wherein the first electrode pattern is formed with a short portion to electrically insulate between at least two first electrode patterns and the insulating pattern at a position corresponding to the short portion is formed in a pattern corresponding to the first electrode pattern other than the short portion.

10. The touch panel as set forth in claim 7, wherein a difference between the aperture ratio of the first electrode pattern and the aperture ratio of the insulating pattern is in a range between 0.01% and 5%.

11. The touch panel as set forth in claim 7, wherein the insulating pattern, the first electrode pattern, and the second electrode pattern are formed in a mesh pattern.

12. The touch panel as set forth in claim 7, wherein the first electrode pattern and the second electrode pattern are formed of copper (Cu), aluminum (Al), gold (Au), silver (Ag), titanium (Ti), palladium (Pd), chromium (Cr), nickel (Ni), or a combination thereof.

13. A touch panel, comprising:
a first transparent substrate;
first electrode patterns formed on one surface of the first transparent substrate so as to be in parallel with each other in one direction;
an insulating pattern formed on the first electrode pattern in a pattern corresponding to the first electrode pattern and having an aperture ratio smaller than that of the first electrode pattern;
a second transparent substrate; and
a second electrode pattern formed on one surface of the second transparent substrate so as to be in parallel with each other in a direction in which the second electrode intersects the first electrode pattern,
wherein the first transparent substrate and the second transparent substrate are bonded to the other surface of the first transparent substrate so as to face the second electrode pattern of the second transparent substrate.

14. The touch panel as set forth in claim 13, wherein the first electrode pattern is formed with a short portion to electrically insulate between at least one first electrode patterns and the insulating pattern facing the short portion is formed in a pattern corresponding to the first electrode pattern other than the short portion.

15. A touch panel, comprising:
a window substrate;
bezel layers formed at both ends of the window substrate;
an insulating pattern formed to have a step corresponding to the bezel layer;
a first transparent substrate;
first electrode patterns formed on one surface of the first transparent substrate so as to be in parallel with in one direction and formed to have an aperture ratio larger than that of the insulating pattern;
a second transparent substrate; and
a second electrode pattern formed on one surface of the second transparent substrate so as to be in parallel with each other in a direction in which the second electrode intersects the first electrode pattern,
wherein the first transparent substrate and the second transparent substrate are bonded to the other surface of the first transparent substrate so as to face the second electrode pattern of the second transparent substrate.

16. The touch panel as set forth in claim 15, wherein the bezel layer is formed of a carbon-based material (graphene oxide, diamond line carbon (DLC)), chromium-based oxide (CrO, CrO₂), copper-based oxide (CuO), manganese-based oxide (MnO₂), cobalt-based oxide (CoO), sulfides (CoS₂, Co₃S₄), nickel-based oxide (Ni₂O₃), titanate oxide (TiO₂), aluminum oxide (Al₂O₃), magnesium-based oxide (MgO), sodium-based oxide (Na₂O), lithium-based oxide (Li₂O), beryllium-based oxide (BeO), magnesium-based sulfide (MgS), or a combination thereof.

17. The touch panel as set forth in claim 15, wherein the first electrode pattern is formed with a short portion to electrically insulate between at least one first electrode patterns and the insulating pattern facing the short portion is formed in a pattern corresponding to the first electrode pattern other than the short portion.

18. The touch panel as set forth in claim 15, wherein the insulating pattern and the electrode pattern are formed in a mesh pattern.

19. The touch panel as set forth in claim 15, wherein the electrode pattern is formed to correspond to the insulating pattern and a difference between the aperture ratio of the electrode pattern and the aperture ratio of the insulating pattern is formed to be in a range between 0.01% and 5%.

20. The touch panel as set forth in claim 15, wherein the electrode pattern is formed of copper (Cu), aluminum (Al), gold (Au), silver (Ag), titanium (Ti), palladium (Pd), chromium (Cr), nickel (Ni), or a combination thereof.

21. The touch panel as set forth in claim 15, wherein an adhesive layer formed of an optically clear adhesive is formed between the window substrate and the transparent substrate.

22. A touch panel, comprising:
a window substrate;
bezel layers formed at both ends of the window substrate;
an insulating pattern formed to have a step corresponding to the bezel layer;
a transparent substrate;
a first electrode pattern formed on one surface of the transparent substrate in a pattern corresponding to the insulating pattern and having an aperture ratio larger than that of the insulating pattern; and
a second electrode pattern formed on the other surface of the transparent substrate and formed in a direction in which the second electrode pattern intersects the first electrode pattern,
wherein the window substrate is bonded to one surface of the transparent substrate in a direction in which the window substrate faces one surface of the transparent substrate.

23. The touch panel as set forth in claim 22, wherein the first electrode pattern is formed with a short portion to electrically insulate between at least one first electrode patterns and the insulating pattern facing the short portion is formed in a pattern corresponding to the first electrode pattern other than the short portion.
